(19) United States
(12) Patent Application Publication
(10) Pub. No.: US 2014/0274057 A1
(43) Pub. Date: Sep. 18, 2014

(54) SYSTEM AND METHOD FOR WIRELESS SPECTRUM ALLOCATION

(71) Applicant: CURIOSITATE, INC., Cambridge, MA (US)

(72) Inventor: Elan Y. Pavlov, Cambridge, MA (US)

(73) Assignee: CURIOSITATE, INC., Cambridge, MA (US)

(21) Appl. No.: 14/175,134

(22) Filed: Feb. 7, 2014

Related U.S. Application Data
(60) Provisional application No. 61/776,992, filed on Mar. 12, 2013.

(51) Int. Cl. H04W 36/16; H04W 72/08

(52) U.S. Cl. CPC H04W 36/165; H04W 72/082
USPC 455/436; 455/446

(57) ABSTRACT

The invention generally relates to systems and methods for increasing effective spectrum. The invention provides wireless antennas that transmit or receive within a narrow spectrum at distances that overlap the reach of neighboring antennas and that also transmit or receive within a broader spectrum at restricted distances that do not interfere with the operation of neighboring antennas. This way, within a network of antennas, each antenna can use the full band of spectrum for wireless communications.

### CROSS-REFERENCE TO RELATED APPLICATION

This application claims the benefit of, and priority to, U.S. Provisional Application No. 61/776,992, filed 12 Mar. 2013, the contents of which are incorporated by reference.

### FIELD OF THE INVENTION

The invention generally relates to systems and methods for increasing effective spectrum.

### BACKGROUND

Demand for wireless services is rapidly growing in popularity in fields such as aeronautical navigation, space research, maritime communications, and medical applications. People use wireless services for entertainment, information, and phone calls. To provide these services, a company must be able to use a band of the electromagnetic spectrum. In the U.S., spectrum is allocated by the FCC (see 47 CFR §2.106, Feb. 7, 2013). While different nations may have different approaches, in general, spectrum may be obtained by government auction or lottery or from secondary licensing markets.

Unfortunately, once a company has a band of spectrum within which operate, logistical considerations limit what the company can do. To avoid holes in service, a network must include antennas with overlapping geographical reach. All of those antennas must be operated within that company's band of spectrum to comply with the laws. Since signals from the antennas overlap in space, they must use separate frequencies (or times or codes) from within that band of spectrum to avoid interference. One approach is to break a band of spectrum into subset bands and operate each antenna within one of those subsets. As a result, due to the need to avoid interference, the antennas operate at a fraction of their potential spectral capacity.

### SUMMARY

The invention provides wireless antennas that transmit or receive within a narrow spectrum at distances that overlap the reach of neighboring antennas and that also transmit or receive within a broader spectrum at restricted distances that do not interfere with the operation of neighboring antennas. This way, within a network of antennas, each antenna can use the full band of spectrum for wireless communications. Where the antenna is using the broad band spectrum to communicate with a device that is within the restricted, non-interfering distance, if the device is likely to move to a neighboring antenna, then an intra-antenna handoff can cause the antenna to communicate with the device using the narrow spectrum. Once the device moves into the zone where transmissions from neighboring antennas substantially overlap, an inter-antenna handoff can cause the device to communicate with the neighboring antenna using the neighboring antenna's narrow-spectrum, overlap-reaching band. In this way, each antenna can use the entire broad spectrum for its operations. A company can deploy a network of antennas that effectively operate across the full spectrum to which that company has access.

In certain aspects, the invention provides a method for wireless communication that includes transmitting a signal at a first frequency within a first band of spectrum between a stationary base antenna and a mobile device, performing an intra-antenna handoff so that the signal is transmitted at a second frequency within a second band of spectrum between the stationary base antenna and the mobile device, and initiating an inter-antenna handoff with a result that the signal is transmitted at a third frequency within a third band of spectrum between the mobile device and a second stationary base antenna. Preferably, the second band of spectrum is within the first band of spectrum. The second band and the third band need not have overlapping frequencies. The third band and the first band may have at least partially overlapping frequencies. The stationary base antenna and the second stationary base antenna may be located a fixed distance d apart from one another and the signal at the first frequency is transmit with a strength that falls below a pre-determined threshold at a radius r from the stationary base antenna and r<d (e.g., r may be less than about 0.4 d). In some embodiments, the method includes determining r to be less than about (d−(0.5×d)/cos(30)). Transmission of the signal at the first frequency may be controlled by a computer device operably coupled to the stationary base antenna (e.g., to control signal strength, spectrum allocation, or both).

In certain embodiments, the first band of spectrum is broader than the second band of spectrum, transmissions from the base antenna within the first band of spectrum have a first geographical area, transmissions from the base antenna within the second band of spectrum have a second geographical area, and transmissions from the second stationary base antenna within the third band of spectrum have a third geographical area. The second and third geographical areas overlap substantially and the first and the third geographical areas do not overlap enough that transmissions from the base antenna within the first band of spectrum interfere with transmissions from the second stationary base antenna within the third band of spectrum.

In related aspects, the invention provides a method of transmitting a signal by obtaining, via a computer system, a distance d from a base antenna to a second base antenna; determining an interference distance r based on d (e.g., r<d; r less than about 0.4 d; or r<0.422d); and transmitting a signal from the base antenna to a computer device at a frequency having a signal strength such that at the distance r from the base antenna, the signal strength falls beneath an interference threshold. The method preferably includes receiving information about a spectrum band used by the second base antenna and initiating an intra-antenna handoff resulting in transmitting the signal from the base antenna to the computer device at a second frequency outside of the spectrum band. In some embodiments, the signal is transmitted at the second frequency outside of the spectrum band at a second signal strength greater than the signal strength. The second signal strength may meet or exceed the interference threshold at an intermediate distance 0.5d from the base antenna. The method may include initiating an inter-antenna handoff resulting in transmitting the signal from the second base antenna to the computer device at a third frequency within the spectrum band. Optionally, the second base antenna also operates at a second spectrum band wider than the spectrum band, and the method further includes coordinating the operation of the second base antenna to perform a second intra-antenna handoff resulting in transmitting the signal from the second base antenna to the computer device at a fourth frequency outside of the spectrum band and within the second spectrum band.

Aspects of the invention provide a system for communication that includes a plurality of base antennas (e.g., cell towers, satellites, or wireless internet devices) each spaced apart by an average distance d from its nearest neighbors of the plurality of the base antennas, wherein each base antenna operates in a narrow spectrum band to generate a plurality of overlapping cells and operates in a broad spectrum band to generate a plurality of substantially non-interfering cells. The system may include a computer system with a tangible, non-transitory memory coupled to a processor, the computer system being operably coupled to at least one of the base antennas to control the operations of the base antenna. Each base antenna can be operable to perform an intra-antenna handoff of a connection to a device from within the broad spectrum of that base to the narrow spectrum of that base. Additionally, each base antenna may be operable to perform an inter-antenna handoff of the connection to the device from the narrow spectrum of that base to the narrow spectrum of a neighboring base.

In some embodiments, the broad spectrum band is substantially the same for all of the plurality of substantially non-interfering cells; the broad spectrum band substantially includes all of the narrow spectrum bands of the plurality of overlapping cells; the narrow spectrum bands comprise spectrum that is more penetrant than the broad spectrum band; the broad spectrum band substantially overlaps all of the narrow spectrum bands; or a combination thereof. In certain embodiments, the plurality of base antennas use overlapping codes simultaneously with the overlapping spectrum bands.

In certain aspects, the invention provides a method of transmitting a signal, the method comprising: obtaining, via a computer system, a distance d from a base antenna to a second base antenna; determining an interference distance r based on d; and transmitting a signal from the base antenna to a computer device at a frequency having a signal strength such that at the distance r from the base antenna, the signal strength falls beneath an interference threshold.

In some embodiments, the methods comprises receiving information about a spectrum band used by the second base antenna; initiating an intra-antenna handoff resulting in transmitting the signal from the base antenna to the computer device at a second frequency outside of the spectrum band. In certain embodiments, r<d. In certain embodiments, r is less than about 0.4 d. In certain embodiments, determining the interference distance r includes calculating (d−(0.5×d)/cos(30)).

In some embodiments, the methods comprises transmitting the signal at the second frequency outside of the spectrum band at a second signal strength greater than the signal strength. In certain embodiments, the second signal strength meets or exceeds the interference threshold at an intermediate distance 0.5d from the base antenna. In some embodiments, the methods comprises initiating an inter-antenna handoff resulting in transmitting the signal from the second base antenna to the computer device at a third frequency within the spectrum band.

In certain embodiments, the second base antenna also operates at a second spectrum band wider than the spectrum band, the method further comprising coordinating the operation of the second base antenna to perform a second intra-antenna handoff resulting in transmitting the signal from the second base antenna to the computer device at a fourth frequency outside of the spectrum band and within the second spectrum band.

In certain aspects, the invention provides a method of performing an intra-cell handoff, the method comprising: using a base antenna to transmit a signal between the antenna and a device at a frequency; determining information about the spectrum, quality, and distance of the transmission; and performing an intra-cell handoff based on the information with the result that the base antenna transmits a signal between the antenna and the device at a second frequency.

### BRIEF DESCRIPTION OF THE DRAWINGS

FIG. 1 shows a network for wireless services including a plurality of antennas.

FIG. 2 illustrates a geographical area of transmissions of an antenna.

FIG. 3 diagrams an arrangement among antennas according to some embodiments.

FIG. 4 depicts an antenna with a second set of transmissions of restricted strength.

FIG. 5 depicts a directional antenna with a second set of transmissions of restricted strength in each 60° sector.

FIG. 6 gives relationships between two neighboring antennas.

FIG. 7 reveals spectrum allocation between two neighboring antennas.

FIG. 8 charts methods according to certain embodiments.

### DETAILED DESCRIPTION

The invention provides systems and methods by which a network for wireless services that includes a plurality of antennas can beneficially use a maximal amount of the spectrum allocated to that network. There are many examples of networks or allocations of spectrum which cover large areas. Examples of such networks include cell-phone networks, radio bandwidth, TV networks or large area Wi-Fi networks. Any wireless network may be benefited by methods and systems of the invention. For example, a network within the so-called TV whitespace (e.g., corresponding to about 54 MHz to 698 MHz) freed up by the U.S. digital transition may employ methods disclosed herein. In some embodiments, a network for mobile cellular phones is used. Systems and methods of the invention can be used with networks as described in U.S. Pat. No. 8,315,658 to Chun; U.S. Pat. No. 8,311,509 to Feher; U.S. Pat. No. 8,279,823 to Stanforth; U.S. Pat. No. 8,165,593 to Kim; and U.S. Pub. 2012/0258753 to Stanforth, the contents of each of which are incorporated by reference. These networks may cover large areas seamlessly from multiple sources (e.g., cell phone towers or WI-FI points of access). In general, a network will operate within a certain band of spectrum.

Preferably, the network will include a plurality of antennas that are operated to cover an area entirely (without gaps). Most deployments can be modeled as substantially planar (e.g., along a surface of the globe). To ensure complete coverage, and to facilitate handoffs, there will be overlap between transmissions from neighboring antennas (e.g., towers, within a cellular network). To prevent interference, neighboring towers preferably do not have transmissions within the same spectrum, within the overlapping area, that exceed some interference threshold. (Due to the geometries of signal decay and nature of propagation of electromagnetic waves, an undesired signal may propagate to any arbitrary distance. However, once beneath the interference threshold it can be treated as not present and ignored for it will not interfere significantly.) Thus, neighboring towers will be allocated different bands of spectrum for the signals that overlap.

FIG. 1 presents a map of an exemplary network 100 according to some embodiments. Network 100 includes any number n of antennas 101a, 101b, 101c, . . . , 101n. Each antenna may be a single antenna or may comprise multiple operational antennas. For example, in some embodiments, each antenna 101 is a cell tower that includes three sectors. Network 100 is allocated a band of spectrum within which the towers 101 operate to communicate with devices such as mobile phones.

A band of spectrum may be identified arbitrarily as including A-D MHz (where A-D can represent any values along the electromagnetic spectrum; also, read A-D as “A through D”). Network 100 may be allowed to use that band of spectrum. Two neighboring towers (in the case of a cell network) will each be able to reach some distance x to define two areas that overlap.

FIG. 2 illustrates overlap of areas from neighboring towers. Here, tower 101a operates to reach a distance x meters, defining an area 107a (e.g., of π×2 meters). Tower 101c operates to reach all of area 107c. The first tower 101a may be arbitrarily assigned a narrow band of the spectrum, say B only, while the tower 101c is assigned, for example, D only. Thus, in the overlapping area, signals from the first and second tower do not interfere with one another. Signals within the narrow-band of spectrum including B come from the first tower, while signals within the narrow band of spectrum including D come from the second tower.

This arrangement and allocation of spectrum allows for handoffs from the first tower to the second tower. The need for transparent handovers requires e overlap between two adjacent transmission areas, i.e., overlap requires allocation of different spectrum to different transmitters. To optimize coverage, it is preferable that the towers 101 are arranged across the coverage area to simultaneously minimize overlap while also minimizing or excluding holes in coverage.

FIG. 3 diagrams an arrangement of towers 101 in network 100 to optimize coverage. All of the towers 101 can be spaced equidistantly apart, or the spacing between pairs of towers can have a mean, median, or mode distance d. Any given tower 101a may preferably have about six nearest neighbors (a representative three are shown in FIG. 3). For any pair of those neighbors 101b and 101d that are spaced apart from one another by approximately or precisely the same distance d that they are spaced apart from given tower 101a, a line extending from tower 101a to tower 101b defines an angle θ with a line extending from tower 101a to tower 101d. Building network 100 across a landscape (e.g., for cellular service) or within a facility or campus (e.g., for wireless service) or through space (e.g., for satellites) may require non-uniform distribution of resources, as nature is, in-fact, organic and irregular. As a result, any given angle θ may have an arbitrary value. Preferably, taken across an extended area of network 100, numerous instances of angle θ define an average value that approaches 60° (e.g., may be between about 30° and about) 90°. In some embodiments, a plurality of towers 101 (e.g., a subset of all of towers 101 in network 100) define numerous instances of angle θ that are between about 40° and about 80°. In general, the distance d will relate to the electromagnetic field that is generated by the towers 101.

There are various ways of shaping the electromagnetic field used for transmitting data. Shaping the electromagnetic field allows one to limit the transmissions to be beneath the interference threshold (i.e., to be effectively non-existent) outside of a certain area. Two common ways of shaping the electromagnetic field include reducing the power of a transmitter in order to limit the range or tilting the transmitter in order to prevent signals from travelling more than a desired angle. Both of these techniques are used to limit the interference between transmitters. In addition, some devices (e.g. cellphone towers) may be divided into different angles, or sectors, in which control is exercised within each sector independently.

In the areas of geographical, or physical, overlap between the useful electromagnetic field generated by neighboring towers 101, it is preferable that there not be overlap between the bandwidth of those towers, and thus operations can include limiting the bandwidth that a transmitter uses. Existing protocols may be used to determine bandwidth allocation in this regard. For example, the Global System for Mobile communication (GSM) (formerly Groupe Special Mobile) provides a cellular network with its entire geographical range divided into hexagonal cells. Each cell has a communication tower which connects with mobile phones within the cell. All mobile phones connect to the GSM network by searching for cells in the immediate vicinity. GSM networks operate in only four different frequency ranges. Each cellphone tower uses a quarter of the total bandwidth that is available for that network for transmissions that will overlap physically with neighboring towers (and without methods and systems of the invention, GSM-style networks would be limited to only using a quarter of the total bandwidth made available for that network per tower). GSM-style networks are described in more detail in U.S. Pat. No. 7,167,707 to Gazzard; U.S. Pub. 6,748,236 to Barbey; U.S. Pat. No. 6,023,459 to Clark; U.S. Pub. 2012/0329508 to Kanerva; U.S. Pub. 2008/0227469 to Burgess; and U.S. Pub. 2002/0082003 to Chervatin, the contents of each of which are incorporated by reference in their entirety for all purposes. While described just above in terms of GSM cellular mobile networks, concepts and methods of the invention may be implemented in any suitable system such as, for example, wireless internet, or Wi-Fi systems, television, radio, satellites, or a combination thereof. Once it is determined what band of spectrum each tower 101 will use to generate electromagnetic fields that usefully overlap (remembering that overlap is useful for successful hand-offs), then distance d is determined based on, among other things, a strength at which a tower 101 will transmit.

For a given signal strength, a tower 101 will create an electromagnetic field 107 with a useful radius x. In preferred embodiments, field 107a from tower 101a will overlap field 107n from any nearest neighbor tower 101n, but will not overlap (above some effective threshold power) the field 107p from any next-nearest neighbor tower 101p or any more distal tower. Accordingly, the strength of transmissions from a tower 101 are controlled such that x<d. This provides transmission that overlap in space for the narrow band of spectrum allocated to each tower 101 for the purpose of overlapping transmissions (i.e., to allow for successful inter-tower handoffs).

In addition to transmissions that overlap in space and use a narrow band of spectrum, the invention provides an additional transmission capacity for each antenna (e.g., each sector of a cell tower) within a system 100. One insight included in the invention is that merely controlling the transmission from a tower 101 or even within a given angle (e.g., sector) may be improved upon. The invention provides additional levels of control within a given tower 101 or angle thereof. In some embodiments, additional control is predicated on a model that may be derived from a starting model in which a signal from each transmitter 101 is modeled as circular.

FIG. 4 depicts a model of a network 100 according to certain embodiments. For a given set of modeled transmitters 101a, 101b, . . . 101n and a set of broadcast circles 107a, 107b, . . . , 107n around them, a planar graph may be created in which each transmitter 101 is a node and neighboring broadcast circles 107 between transmitters overlap. Network 100 may effectively use a much larger portion of the available spectrum if one or more of towers 101 has more than one transmission.

As shown in FIG. 4, tower 101a broadcasts a signal to an effective radius x to create a broadcast area 107a. Tower 101a may further use a greater amount of the available spectrum if tower 101a also broadcasts one or more additional signals in such a fashion (e.g., at a lower power, or by a dipped antenna) that the additional signals have a signal strength beneath an interference threshold at a radius r. These additional signals thus define a broad-spectrum broadcast area 111a associated with tower 101a. Broad-spectrum broadcast area 111a is a subset of the overlapping broadcast circle 107a, in which narrow-spectrum transmissions are broadcast.

As shown in FIG. 5, tower 101a may additionally have separate directional antennas covering the area around it, dividing its broadcast area 107a into sectors, and exercising control in each sector independently. Let sector 107ab be the sector of broadcast circle 107a that is centered in the direction from tower 101a to tower 101b. Then most sectors may be chosen so that sector 107ab of broadcast circle 107a is covered only by broadcasts from towers 101a and 101b, allowing it to use a full half of the available spectrum. As in FIG. 4, the broad-spectrum broadcast area 111ab is still able to use all of the available spectrum.

FIG. 6 depicts the operation of these methods as between one exemplary pair of antennas 101a and 101c. Antenna 101a broadcasts in a narrow spectrum to a distance x, to define an overlapping broadcast circle 107a. Antenna 101a broadcasts in a broad spectrum signals that fall beneath an interference threshold by a radius r defining a broad-spectrum broadcast area 111a. Simultaneously, antenna 101b broadcasts in a narrow spectrum to a distance x, to define an overlapping broadcast circle 107b. Antenna 101b broadcasts in a broad spectrum signals that fall beneath an interference threshold by a radius r defining a broad-spectrum broadcast area 111b. Preferably, antenna 101a is spaced from antenna 101b by a distance d. In some embodiments, a strength of the broad spectrum signal is determined by making reference to distance d. A system administrator may determine that a strength of the broad spectrum signal must fall beneath an interference threshold by a distance r from a tower 101. Strength may be a function of distance (e.g., exponential or otherwise), intervening geographical features, electromagnetic environment, or a combination thereof. An interference threshold may be determined by experimentation (i.e., if two calls interfere with one another and a typical customer is unhappy with a call quality, the interference threshold is exceeded). Network 100 may be deployed to create an expanse of overlapping cells that do not also exhibit overlap of more than two cells in substantial amounts of area. It may be preferable to achieve this by modeling cells as a network of tessellated hexagons. Accordingly, a line from tower 101a to tower 101b on a map model may bisect an edge of a hexagon at 90° and have a length of distance d. In such a case, it may be preferable that d=x+r, precisely or substantially. In some embodiments, d will equal x+r on an average across an extent of network 100. It will be found that this result can be achieved where equation 1 is satisfied.

r<d−((0.5×d)/cos 30) Equation 1

Noting that cos 30 is about 0.8660254, equation 1 can be simplified to reveal that r is preferably less than about 0.42265×d. For many deployments of network 100, it may be preferred that r be less than about 0.4×d. This allows the smaller transmission area 111a to use the full spectrum available while the outer transmission 107a can utilize a much smaller amount of spectrum. For example, in some embodiments, the outer transmission uses 25% or 50% of the available spectrum.

FIG. 7 diagrams spectrum allocation according to certain embodiments. Here, A-D represents the spectrum allocated to a network 100. As shown in FIG. 6, tower 101a uses spectrum A-D for broadcasts within broad band area 111a. Tower 101a uses a subset (e.g., B) of spectrum A-D for broadcasts to outer area 107a. Similarly, tower 101c uses spectrum A-D for broadcasts within broad band area 111c. Tower 101c uses a subset (e.g., D) of spectrum A-D for broadcasts to outer area 107c.

The way spectrum is used in outer circle 107 may be twofold. First, any users in the outer circle who are not also in the inner circle are allocated the narrower band of spectrum. In some embodiments, the area of inner circle 111 is a substantial fraction of the area of outer circle 107 and a number of users in the outer circle who are not in the inner circle is generally small (assuming reasonable and actual distributions).

Additionally, the invention provides systems and methods for spectrum usage that allow for handoffs. Currently, networks use the overlap between transmitters (e.g., cell phone towers) to enable handoffs between adjacent towers. For example, a mobile device (e.g., a cell phone) in the overlap can connect to both towers (on different spectra). This means a device can transfer from one tower to another. Methods for inter-antenna handoffs are known in the art. For example, there are hard handoffs, soft handoffs etc. Fortunately, due to a lot of work by the various broadcasters handoffs are very smooth and users can not really detect a handoff.

Systems and methods of the invention provide inter-antenna handoffs and intra-antenna handoffs. For example, where a cell phone user is walking between tower 101a and 101c (see FIG. 6), the user is initially allocated a frequency within A-D (since the user starts in the internal circle 111a and we preferentially allocate spectra in A-D to users in the inner circle 111a). As the user approaches the area of outer circle 107a which is not in inner circle 111a, system 100 initiates an intra-antenna handoff to a frequency within B (since the that area is only covered by B). A handoff can be initiated when it is determined to be useful. For example, where the user is observed to be moving away from tower 101 and towards tower 101c. Such a determination can be made by the user's motion or distance, e.g., as described in U.S. Pat. No. 5,239,667 to Kanai, the contents of which are incorporated by reference. Note that since B is broadcast over both inner circle 111a and outer circle 107a, there is area in which to do intra-antenna handoffs). At some point, the user is in outer circle 107a and not in inner circle 111a. As the user continues, the user will reach an area of overlap between outer circle 107a and outer circle 107c. In this area of overlap, system 100 initiates an inter-tower handoff from tower 101a to tower 101c (e.g., from a frequency within B to a frequency within D). Finally as the user continues towards tower 101c, system 100 may optionally initiate an additional intra-antenna handoff to any frequency within A-D as covered by circle 111c (so that we can preferentially allocate bandwidth within A-D to users in inner circle 111c). In some embodiments, no further handoffs are required. Fewer handoffs may be performed. It will be appreciated that FIG. 8 provides a diagram of this method.

It is noted that A-D may represent an suitable band of spectrum and may optionally be further broken down into any suitable narrower bands of spectrum. For example, A-D may represent 400-700 MHz. In some embodiments, the invention has application in 3G, 4G, MediaFlo, and DVB-H technologies using the 700 band. The band may include 698-806 MHz. In some embodiments, the invention has application in SMR iDEN, ESMR CDMA (future), ESMR LTE technologies, using the 800 band. The band may include 806-824 and 851-869 MHz. In some embodiments, the invention has application in GSM, IS-95 (CDMA), 3G technologies using the 850 band. The band may include 824-849 and 869-894 MHz. In some embodiments, the invention uses the 1400 band. The band may include 1,392-1,395 and 1,432-1,435 MHz. In some embodiments, the invention has application in GSM, IS-95 (CDMA), 3G, 4G technologies, using the so-called PCS band. The band may include 1,850-1,910 and 1,930-1,990 MHz. In some embodiments, the invention has application in 3G, 4G technologies, using the AWS band. The band may include 1,710-1,755 and 2,110-2,155 MHz. In some embodiments, the invention has application in 4G technologies, using the BRS/EBS band. The band may include 2,496-2,690 MHz.

Compare this to the current method in which only a single handoff is required. However, the overhead of handoffs is minimal. Systems and methods for performing handoffs are described in U.S. Pat. No. 8,279,836 to Ma; U.S. Pat. No. 7,299,019 to Austin; U.S. Pat. No. 6,889,046 to Mohebbi; U.S. Pat. No. 6,542,744 to Lin; U.S. Pat. No. 6,208,631 to Kim; U.S. Pat. No. 6,111,864 to Kabasawa; U.S. Pat. No. 5,555,445 to Booth; U.S. Pat. No. 5,345,467 to Lomp; U.S. Pat. No. 5,164,958 to Omura; and U.S. Pub. 2012/0258717 to Handforth, the contents of which are incorporated by reference for all purposes.

Since the smaller circles can contain most of the area of the larger circle and since the full spectrum can be used within the smaller circle, an increase in available spectrum can be realized.

In certain embodiments, the two transmissions do not have to originate from the same location. In some embodiments, the same origin is used to yield a gain in efficiency and to invoke few regulatory issues.

The method can also be implemented by reducing the overlap between the inner and outer circle. For example, the outer circle can be replaced with a ring. The number of handoffs may still be the same. However, multiple rings can be used to get better savings (since each ring serves a small area).

Systems and methods of the invention are useful when spectrum is available that exhibits varying properties. For example, a more penetrant or longer-carrying spectrum can be used for a larger circle 107, and other spectrum can be used for an internal circle 111. This allows both better use of the spectrum as well as synergies between the properties of the different spectra.

One benefit of methods of the invention lies in that barriers to deployment can be quite low. Deployment need not require additional bandwidth and can utilize techniques such as tilting or power control in order to achieve a desired shift in range. In addition, given the current bandwidth allocations it can easily be deployed in some applications today. For example, the FCC already allocates the spectrum to mobile providers. Even using current cell tower approvals and bandwidth allocated any mobile provider can utilize the system. The system is backward compatible and works with MIMO and LTE. There are other applications where the barrier to deployment is lowered by aspects of the invention. For example, looking at radio or TV in which different providers own different geographic licenses, deployment might be facilitated by arbitration or other intervention by regulators. Where network 100 is a large-area WI-FI deployment (e.g., in a large organization that has WI-FI spread over a large area), the deployment can be done easily by using a computer system (including a processor coupled to a tangible, non-transitory memory) to operate each Wi-Fi antenna to exhibit transmission patterns such as those diagramed in, e.g., FIG. 6. In other WI-FI applications such as residential applications, deployment of network 100 can be aided by some coordination either actively using e.g., handshake agreements or passively using e.g., backoff protocols. Backoff protocols are described in U.S. Pat. No. 7,155,524 to Reiter and U.S. Pat. No. 5,717,889 to Rettig, the contents of which are incorporated by reference.

While the discussion above applies to systems in which the interference between adjacent towers is in the frequency domain, similar considerations apply to other methods. Frequency reuse is the ability to reuse the same radio channel frequency at other cell sites within a cellular system. A network 100 may operate as a frequency division multiple access (FDMA) system, a time division multiple access (TDMA) system, a code division multiple access (CDMA), use other systems, or a combination thereof. A computer controller system can control operations of antennas 101 to ensure signals from different cells do not interfere with each other. In a Code division multiple access (CDMA) system, the same frequency can be used in every cell, because channelization is done using the pseudo-random codes. Reusing the same frequency in every cell eliminates the need for frequency planning in a CDMA system. Planning of the different pseudo-random sequences is done to ensure that the received signal from one cell does not correlate with the signal from a nearby cell.

One of ordinary skill in the art will appreciate that the same method to allow reuse of frequencies within cells apply to the reuse of codes between cells. The effect in both cases is to increase the available capacity of the channel. In addition for CDMA the increased reuse of codes decreases the noise threshold and hence the required power.

Similar analysis is clear for other technologies such as Orthogonal Frequency Division Multiple Access (OFDMA) in which orthogonal bandwidths are allocated.

In general the method will work for any system in which collaboration or division of resources is required by overlapping or adjacent transmitters. This includes such standards as TV, radio, WI-FI (TV, Radio and WI-FI share in the frequency domain), GSM (which is an example of TDMA with sharing in time domain), CDMA (sharing in the code domain), OFDMA (frequency domain), FDMA (sharing in the frequency domain) as well as many other technologies. Networks for use with the invention are described in U.S. Pat. No. 8,311,055 to Senarath; U.S. Pat. No. 7,139,258 to Tillotson; U.S. Pat. No. 6,970,448 to Sparrell; U.S. Pat. No. 5,570,352 to Poyhonen; U.S. Pat. No. 4,774,708 to Hotta; U.S. Pat. No. 2013/0016603 to Novak; U.S. Pat. No. 2012/0281641 to Cui; and U.S. Pub. 2012/0243447 to Weissman, the contents of each of which are incorporated by reference.

In some embodiments, systems and methods of the invention provide femtocells or umbrella cells for use in wireless networks.

While described herein in terms of one or more base antenna that may be stationary, it will be appreciated that the antenna need not be stationary. For example, the invention may find particular application in a movable peer-to-peer network. For example, a collection of mobile devices may operate cooperatively, each as a wireless “hotspot” to provide a p2p network, with each antenna optionally moving. In certain embodiments, networks according to the invention are deployed to provide a wireless service in an environment that inherent moves, such as an airplane, cruise ship, or public transit vehicle. Networks according to the invention may have particular application in such embodiments, due to the beneficial efficient use of spectrum.

While described herein in terms of a network that preferably has no gaps in areas of coverage, one of ordinary skill in the art will appreciate that that is a context-specific aspirational goal. A network may have one or any number of gaps. A gap may be persistent to fleeting (e.g., with clouds or weather). A gap may be inadvertent or intentional (e.g., a network may be deployed that does not try to cover the center of a large corn field, or national forest, or the Salton Sea.

One of ordinary skill in the art will recognize that spectrum allocation according to the invention may have particular application in the complementary or related technical field of beamforming.

In some embodiments, spectrum is generally allocated to a tower based on neighbors. In certain embodiments, spectrum allocation of a cell is a subset of another cell (which may apply to any network described herein, e.g. femtocells) and the allocation is determined by the allocation to the cell which contains it.

In certain embodiments discussed herein, distances between cells are described in terms of mean distances. It will be understood that this is a useful expository tool and networks as described in the appending claims may be deployed in circumstances where distances vary widely (e.g., networks covering a mixture urban and rural environments).

It is noted that the invention provides systems and methods for performing intra-cell handoffs based on spectrum, quality, distance, or a combination thereof. Methods include using a base antenna to transmit a signal between the antenna and a device at a frequency, determining information about the spectrum, quality, and distance of the transmission, and performing an intra-cell handoff based on the information with the result that the base antenna transmits a signal between the antenna and the device at a second frequency. In particular, the need for an intra-cell handoff may be determined by one or more of spectrum, quality, or distance meeting or exceeding a threshold (e.g., a pre-determined threshold).

As used herein, the word “or” means “and or or”, sometimes seen or referred to as “and/or”, unless indicated otherwise.

### INCORPORATION BY REFERENCE

References and citations to other documents, such as patents, patent applications, patent publications, journals, books, papers, web contents, have been made throughout this disclosure. All such documents are hereby incorporated herein by reference in their entirety for all purposes.

### EQUIVALENTS

Various modifications of the invention and many further embodiments thereof, in addition to those shown and described herein, will become apparent to those skilled in the art from the full contents of this document, including references to the scientific and patent literature cited herein. The subject matter herein contains important information, exemplification and guidance that can be adapted to the practice of this invention in its various embodiments and equivalents thereof.

What is claimed is:

1. A method for wireless communication, the method comprising:
transmitting a signal at a first frequency within a first band of spectrum between a stationary base antenna and a mobile device;
performing an intra-antenna handoff so that the signal is transmitted at a second frequency within a second band of spectrum between the stationary base antenna and the mobile device; and
initiating an inter-antenna handoff with a result that the signal is transmitted at a third frequency within a third band of spectrum between the mobile device and a second stationary base antenna.

2. The method of claim 1, wherein the second band of spectrum is within the first band of spectrum.

3. The method of claim 1, wherein the second band and the third band do not have overlapping frequencies.

4. The method of claim 1, wherein the third band and the first band have at least partially overlapping frequencies.

5. The method of claim 1, wherein the stationary base antenna and the second stationary base antenna are located a fixed distance d apart from one another and the signal at the first frequency is transmit with a strength that falls below a pre-determined threshold at a radius r from the stationary base antenna and r<d.

6. The method of claim 5, wherein r is less than about 0.4 d.

7. The method of claim 5, further comprising determining r to be (d−(0.5×d)/cos(30)).

8. The method of claim 5, wherein transmission of the signal at the first frequency is controlled by a computer device operably coupled to the stationary base antenna.

9. The method of claim 1, wherein:
the first band of spectrum is broader than the second band of spectrum;
transmissions from the base antenna within the first band of spectrum have a first geographical area;
transmissions from the base antenna within the second band of spectrum have a second geographical area;
transmissions from the second stationary base antenna within the third band of spectrum have a third geographical area;
the second and third geographical areas overlap substantially; and
the first and the third geographical areas do not overlap enough that transmissions from the base antenna within the first band of spectrum interfere with transmissions from the second stationary base antenna within the third band of spectrum.

10. A system for communication, the system comprising:
a plurality of base antennas each spaced apart by an average distance d from its nearest neighbors of the plurality of the base antennas, wherein each base antenna operates in a narrow spectrum band to generate a plurality of overlapping cells and operates in a broad spectrum band to generate a plurality of substantially non-interfering cells.

11. The system of claim 10, further comprising a computer system comprising a tangible, non-transitory memory coupled to a processor, the computer system being operably coupled to at least one of the base antennas to control the operations of the base antenna.

12. The system of claim 10, wherein each base antenna is operable to perform an intra-antenna handoff of a connection to a device from within the broad spectrum of that base to the narrow spectrum of that base.

13. The system of claim 12, wherein each base antenna is operable to perform an inter-antenna handoff of the connection to the device from with the narrow spectrum of that base to the narrow spectrum of a neighboring base.

14. The system of claim 10, wherein the broad spectrum band is substantially the same for all of the plurality of substantially non-interfering cells.

15. The system of claim 14, wherein the broad spectrum band substantially includes all of the narrow spectrum bands of the plurality of overlapping cells.

16. The system of claim 10, wherein the narrow spectrum bands comprise spectrum that is more penetrant than the broad spectrum band.

17. The system of claim 10, wherein plurality of base antennas are all wireless internet devices.

18. The system of claim 10, wherein plurality of base antennas are all satellites.

19. The system of claim 10, wherein the broad spectrum band substantially overlaps all of the narrow spectrum bands.

20. The system of claim 10, wherein the plurality of base antennas use overlapping codes simultaneously with the overlapping spectrum bands.
